(19) United States
(12) Patent Application Publication
(10) Pub. No.: US 2008/0061994 A1
(43) Pub. Date: Mar. 13, 2008

(54) Radionuclide Detector and Software for Controlling Same

(76) Inventors: Charles A. Gentile, Plainsboro, NJ (US); Andrew F. Carpe, Hammonton, NJ (US); Stephen W. Langish, Easthampton, NJ (US)

Correspondence Address: GIBBONS P.C., ONE GATEWAY CENTER, NEWARK, NJ, 07102, US

(21) Appl. No.: 11/753,309

(22) Filed: May 24, 2007

Related U.S. Application Data
(63) Continuation of application No. 11/017,215, filed on Dec. 20, 2004.
Application No. 11/017,215 is a continuation of application No. 10/384,236, filed on Mar. 6, 2003, now abandoned.
(60) Provisional application No. 60/530,539, filed on Dec. 18, 2003.

(51) Int. Cl. G08B 21/02

(52) U.S. Cl. 340/600

(57) ABSTRACT

A detector for detecting the presence of suspect radionuclides in a target is disclosed. The detector includes a first detection channel for a first detecting neutron emissions in the target and for providing a first output in accordance with the first detecting, a second detection channel for a second detecting x-ray emissions in the target and for providing a second output in accordance with the second detecting, a third detection channel for a third detecting and an identifying of gamma emissions in the target and for providing a third output in accordance with the third detecting and identifying, a signal manipulation electrically coupled to each of the first, second, and third detection channels, the signal manipulation for receiving the first, second and third outputs and for processing those outputs, and at least one processor electrically coupled to the signal manipulation. The processor determines if the suspect radionuclide is present in the target and provides an alert when the suspect radionuclide is present in the target.

### PRIORITY INFORMATION

This application is a continuation of U.S. patent application Ser. No. 11/017,215, entitled “Radionuclide Detector And Software For Controlling Same,” filed Dec. 20, 2004, which is a continuation of U.S. patent application Ser. No. 10/384,236, filed Mar. 6, 2003, entitled “Miniature Multinuclide Detection System and Methods,”, and which also claimed the benefit of U.S. Provisional Application Ser. No. 60/530,539, entitled “Miniature Integrated Nuclear Detection System With Improved Detection Capability”, filed Dec. 18, 2003, the entire disclosures of which are hereby incorporated by reference herein.

### GOVERNMENT INTERESTS

The inventions described herein have been developed for, pursuant to, or with the assistance of, the United States government. These inventions may be manufactured, used and licensed by or for the United States government for United States government purposes.

### FIELD OF THE INVENTION

The present invention is directed to the detection of radionuclides, and, more specifically, to a system, method and apparatus for the detection and identification of radionuclides, and to a software controller for a system, method and apparatus for the detection and identification of radionuclides.

### BACKGROUND

Radiation is a term used to describe the process of emitting radiant energy, such as in the form of particles or electromagnetic rays, due to nuclear decay. While there are many different types of radiation, there are five which are dealt with most frequently. These five types of frequently encountered radiation emissions include alpha particles, beta particles, gamma rays, x-rays and neutrons.

An alpha particle is a positively charged particle made up of two neutrons and two protons, and is emitted by certain types of radioactive nuclei. The flow of alpha particles along a given path can be stopped by thin layers of light materials, such as a sheet of paper, and thus alpha particles pose no direct or external radiation threat; however, they can pose a serious health threat if ingested or inhaled.

A beta particle is an electron or positron emitted by certain types of radioactive nuclei. While the flow of beta particles can be stopped by aluminum, beta particles pose a serious direct or external radiation threat and can be lethal depending on the amount, or dose, received. Beta particles, like alpha particles, pose a serious internal radiation threat if inhaled or ingested.

A gamma ray is a high-energy electromagnetic emission by certain radionuclides when the state of those certain radionuclei transitions from a higher to a lower energy state. These gamma rays have high energy and a short wave length, with energies above 1 million eV and wavelengths less than 0.001 nanometers. All gamma rays emitted from a given isotope have the same energy, which has historically enabled scientists to identify which gamma emitters are present in an unknown sample.

X-rays are high-energy electromagnetic emissions from atoms caused when electrons within those atoms fall from a higher energy shell to a lower energy shell. These x-rays, like gamma rays, have high energy and short wavelengths, with energies between 1 thousand and 1 million eV and wavelengths between 0.001 and 1 nanometer. X-ray radiation is between ultraviolet and gamma-radiation in the electromagnetic spectrum.

A neutron is a particle that is found in the nucleus, or center, of an atom. A neutron has a mass approximately equal to that of a proton (about 1 amu, which is roughly 1.6.times. 10-27 kg) but, unlike a proton, a neutron does not carry a charge.

Protons, alpha particles, beta particles, gamma rays and x-rays may cause direct ionization in that these particles or rays transfer at least a portion of the energy thereof upon interaction with matter. This transfer generally occurs by imparting energy to electrons of atoms that have been interacted with. Generally speaking, these ions may be measured by using measuring devices, such as a Geiger counter, for example.

Beta and alpha particles each have mass and charge, and are natural products of the decay of, for example, uranium, radium, polonium, and many other elements. Gamma and x-rays, however, have no mass and no electrical charge. Each is thus pure electromagnetic energy.

Most gamma and x-rays can easily travel several meters through the air and penetrate several centimeters of human tissue. Some emissions have enough energy to pass through the body, exposing all the organs to radiation. Gamma emitting radionuclides do not have to enter the body to be a hazard, as direct external and internal exposure to gamma rays or X-rays are of concern.

A large portion of received gamma radiation largely passes through the body without interacting with tissue, as the body is mostly empty space at the atomic level, and gamma rays are atomically small in size. By contrast, alpha and beta particles inside the body lose all their energy by colliding with tissue and causing damage. X-rays may act in a manner similar to alpha and beta particles, but with slightly lower energy.

Gamma rays do not directly ionize atoms in tissue. Instead, they transfer energy to atomic particles such as electrons (which are essentially the same as beta particles). These energized particles then interact with human tissue to form ions, in the same way radionuclide-emitted alpha and beta particles would. However, because gamma rays have more penetrating energy than alpha and beta particles, the indirect ionizations they cause generally occur further away from the emission source, and consequently, deeper into human tissue. Sources of gamma rays typically include radioactive elements such as Thulium 170, Iridium 192, Cesium 137, and Cobalt 60, while sources of x-rays typically include x-ray tubes within the controlled environment of a medical office.

Neutrons, which are non-charged particles, interact differently. Neutrons interact by colliding with atoms. Neutrons transfer energy during these collisions, in a manner that is similar, conceptually, to the collision of billiard balls. These collisions may be 0-100 percent energy transfers, depending on the speed, angle, and size of the components, according to the laws of physics as would be understood by one of skill in the art.

A more efficient energy transfer may occur between a neutron and a target of the same size. Because of the comparable size of protons, protons often become good targets for energy transfer from a neutron collision. Protons, like the nucleus of a hydrogen atom, when struck by a neutron, may absorb energy and move. Thereby, instead of having a non-charged particle moving through a material, a charged particle is moving, which may give up energy through ionization, as discussed hereinabove. As the neutrons slow, they may be absorbed by atoms. This is one way in which a material may become radioactive, although the absorption of neutrons does not always lead to a radioactive atom.

Sources of neutrons include nuclear reactors, making neutrons by fission and decay of fission products, spent fuel, combining alpha-emitting isotopes like polonium or radiation with beryllium, the transuranium element Cf 252 (which undergoes spontaneous fission), accelerators by photon-neutron production, or smashing a deuterium atom into tritium, thereby producing fusion and neutrons.

While there are many beneficial uses for radioactive materials in the fields of science and medicine, these materials may be highly threatening to society. It goes without saying, radiation poisoning may be a tactic of terrorist groups and other radical factions with the intent to bring harm or even death to others. For example, the use of “dirty bombs”, which add radioactive materials to common explosives, has been well documented. Other possibilities, such as the contamination of food stocks or water sources with radioactive materials, have also been speculated.

The U.S. government does not take these sorts of potential threats lightly. For example, risk priority matrices set forth by the U.S. government include Cs 137 and Co 60, because of the large quantities of these isotopes that exist and, in the case of Cs 137, the ease of dispersal. Sr 90, Pu 238, Am 241 and Ir 192 are also included in the matrix of potential threats. In addition, spent fuel is generally included in potential threat matrices, and needless to say there are very significant quantities of spent fuel available.

Because nuclear devices or threats such as those described above may be assembled or deployed at any location, it would be advantageous for authorities to have the capability of sensing radionuclides at widely dispersed locations. By way of nonlimiting examples, such locations may include automotive highways, bridges, airports, train stations, municipal mass transit systems, governmental buildings, freight handling facilities, and the like. Automating the screening or sensing at such sites may enable the screening at those sites to be free of human intervention when no radionuclides are detected, and yet may readily enable the alerting of appropriate authorities upon a positive detection and/or identification of a specific radionuclide deemed to be a threat.

Thus, there remains a need for automated systems and methods to detect and identify any of a wide range of radionuclides. There is further a need for such systems and methods to operate rapidly, automatically and independently of human intervention. There remains a need for detection and identification systems and methods capable of operating at high volume, and with high throughput. There furthermore remains a need for systems and methods to detect and identify particular radionuclides from among a set of candidate radionuclides that may be deployed in a variety of environments.

### SUMMARY OF THE INVENTION

A detector, system and method for detecting the presence of suspect radionuclides in a target is disclosed. The detector includes a first detection channel for a first detecting neutron emissions in the target and for providing a first output in accordance with the first detecting, a second detection channel for a second detecting x-ray emissions in the target and for providing a second output in accordance with the second detecting, a third detection channel for a third detecting and an identifying of gamma emissions in the target and for providing a third output in accordance with the third detecting and identifying, a signal manipulation electrically coupled to each of the first, second, and third detection channels, the signal manipulation for receiving the first, second and third outputs and for processing those outputs, and at least one processor electrically coupled to the signal manipulation. The processor determines if the suspect radionuclide is present in the target and provides an alert when the suspect radionuclide is present in the target. A method of detecting the presence of radionuclides in a target is also disclosed. The method includes sensing the target using at least one detector, wherein the at least one detector outputs a signal commensurate with a presence of the radionuclides in the target, processing the signal in order to identify a type of the radionuclide, and alerting responsively to the identified radionuclide. Thus, the present invention provides automated systems and methods to detect and identify any of a wide range of radionuclides.

### DESCRIPTION OF THE DRAWINGS

Understanding of the present invention will be facilitated by consideration of the following detailed description of the embodiments of the present invention taken in conjunction with the accompanying drawings, in which like numerals refer to like parts and in which:

FIG. 1 illustrates a block diagram of the system according to an aspect of the present invention;

FIG. 2 illustrates a block diagram of a neutron detector according to the present invention;

FIG. 3 illustrates a block diagram of an x-ray detector according to an aspect of the present invention;

FIG. 4 illustrates a block diagram of a gamma ray detector according to an aspect of the present invention;

FIG. 5A illustrates a set of sample data as may be detected by the gamma ray channel according to an aspect of the present invention;

FIG. 5B illustrates a set of sample data as may be detected by the gamma ray channel according to an aspect of the present invention;

FIG. 5C illustrates a set of sample data as may be detected by the gamma ray channel according to an aspect of the present invention;

FIG. 6 illustrates a configuration according to an aspect of the present invention;

FIG. 7 illustrates a neural networking configuration of the software according to an aspect of the present invention;

FIG. 8 shows a screen shot of the main system screen according to an aspect of the present invention;

FIG. 9 shows a screen shot of the alert for Cs137 according to an aspect of the present invention;

FIG. 10 shows a screen shot of the alert for Am241 according to an aspect of the present invention;

FIG. 11 shows a screen shot of the alert for Co60 according to an aspect of the present invention;

FIG. 12 illustrates a housing according to an aspect of the present invention; and,

FIG. 13 is a flow diagram of a method of detecting radionuclides according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical detection components and methods of manufacturing and using the same. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

The present invention is directed to an apparatus, system and method for detection of neutron and x-ray emissions, and an identification of gamma emissions. One aspect of the invention may include a device and system suitable for recognizing unique radiant energy emission levels or patterns for a radionuclide, for one or more selected from a selected set of radionuclides, or for an unknown sample. According to an aspect of the present invention, the device and system may allow for detection of radionuclides having minimal and trace emission levels. According to an aspect of the present invention, the invention may include communicating not only the presence, but also the identity, of a radionuclide in a sample volume to appropriate personnel at a local or remote location. The invention may include a plurality of methods for accomplishing these detections, identifications, and communications of the device and system, as further described below.

The present invention may detect trace, as well as high level, emissions, at low to very high rates or frequencies. This may allow the device to be installed in virtually any location, especially those locations or facilities where there is a high volume of public traffic, which traffic may be traveling at virtually any rate of speed, or any other locations at or through which there may be a heightened likelihood of the transport of hidden radionuclides. By way of nonlimiting example, these locations may include highways, train stations, airports, shipyards, metropolitan mass transit systems, governmental and commercial buildings, truck terminals, railroad freight handling facilities, and the like.

The present invention may include an alerting function or similar notification of a positive detection of a suspect radionuclide, and an identification of a suspect radionuclide. The suspect radionuclide to be detected may be from a predetermined sample. These capabilities permit assessing the presence of radionuclides from a local or a remote location in real time. For example, the present invention may be installed at a shipping terminal in such a way that shipping containers may pass directly before, or under, one or more detector modules as the containers are offloaded from a vessel. If no emissions are detected, the shipyard tasks carry on without interruption. However, if emissions from a radionuclide are detected, an electronic warning system, such as a warning light, sound, and/or triggering of a portable alarm device carried by a security officer may be activated as the detection occurs, and this warning system may, dependently upon the type of radionuclide emission detected, identify the radionuclide and even the amount of the radionuclide detected, thereby allowing appropriate personnel to evaluate the situation.

The present invention may be used to scan vehicles, cargo containers, and other potential mobile targets, as well as stationary targets, and may provide substantially real-time detections and identifications of gamma emission, and real-time detections of the presence of x-ray or neutrons emissions. Further, because of the identifying nature, rather than solely a detecting nature, of the present invention, benign signatures, such as medical and industrial nuclear signatures, may be separated from suspect signatures as desired, thereby eliminating “false positive” readings that have historically been detrimental to radionuclide alert systems. The present invention is directed to a device, system, and method for detection of gamma, x-ray, and neutron emissions, and software for controlling and enhancing the detection and identification of such emissions. The device and system may include low level detection and integration in a small package. Additionally, while the discussion of the present invention includes elements that may be proximately located to the source of the signals, portions of the device may be located centrally or remotely. The present invention may detect radiation generally, and may detect all or some of the three types of emission discussed herein. According to an aspect of the present invention, the device may be passive.

The present invention may also detect the presence of at least trace amounts of emissions at high rates, or across short accumulation times, permitting use in sensitive and fast moving environments. For example, the present invention may be positioned over a bridge, such that detection of vehicles passing over the bridge may be made. In the event two fast moving vehicles are transporting radionuclides in succession, the device may recognize that two emissions sources are present, and not simply one. This high rate of detection is critical in the above scenario, as the first vehicle could be transporting radionuclides commonly used for medical purposes, while the second vehicle could be carrying radionuclides for terrorist activities. Using again the example of two vehicles crossing a bridge, when the first vehicle contains a very high level of emissions, and the second vehicle contains a trace level of emissions, the detector may recognize that two sources of emissions exist and not one. Thus, the detection and identification of radionuclides at high rates and high sensitivity levels allows for communication of a positive determination of the correct number of emissions sources to appropriate authorities. Further, the use of multiple detector/identifiers in accordance with the present invention may allow for an assessment of distances or amounts of a radionuclide(s) detected and identified, even in high rate or high frequency applications.

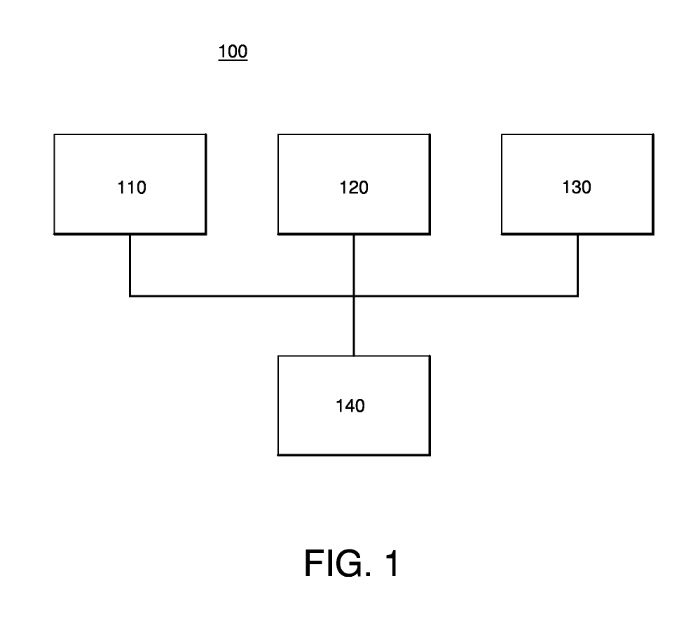

Referring now to FIG. 1, there is shown a block diagram of the system according to an aspect of the present invention. As may be seen in FIG. 1, system 100 may include a first detection channel 110, a second detection channel 120, a third detection channel 130 and processing 140 coupled to each of the channels for interpreting and analyzing the data from each channel. Each channel may be designed to detect signals of interest, commonly referred to throughout this discussion as “emissions”, such as gamma rays, x-rays and neutrons, for example. Other types of channels or combinations of channels may be utilized to detect additional emissions (such as alpha and beta particles), and the number of channels may be greater than or less than three. For the sake of the present discussion of exemplary embodiment(s), three channels will be discussed with regard to detection of gamma rays, x-rays and neutrons, by way of non-limiting example only.

According to an aspect of the present invention, first detection channel 110 may be designed to detect the presence of neutron radiation. Neutron radiation consists of free neutrons. As may be known to those possessing an ordinary skill in the pertinent arts, neutrons may be emitted during nuclear fission, nuclear fusion or from certain other reactions, such as when a beryllium nucleus absorbs an alpha particle and emits a neutron, for example.

Neutron radiation is a form of ionizing radiation that is more penetrating than alpha, beta or gamma radiation. In health physics it is considered a fourth radiation hazard alongside these other types of radiation. Another, sometimes more severe, hazard of neutron radiation is its ability to induce radioactivity in most substances it encounters, including body tissues and instruments. This induced radiation may occur through the capture of neutrons by atomic nuclei. This process may typically account for much of the radioactive material released by the detonation of a nuclear weapon. This process may also present a problem in nuclear fission and nuclear fusion installations, as it may gradually render the equipment radioactive. The neutrons in reactors are generally categorized as slow (thermal) neutrons or fast neutrons, depending on their energy. Thermal neutrons are easily captured by atomic nuclei and are the primary means by which elements undergo atomic transmutation. Fast neutrons are produced by fission and fusion reactions, and have a much higher kinetic energy.

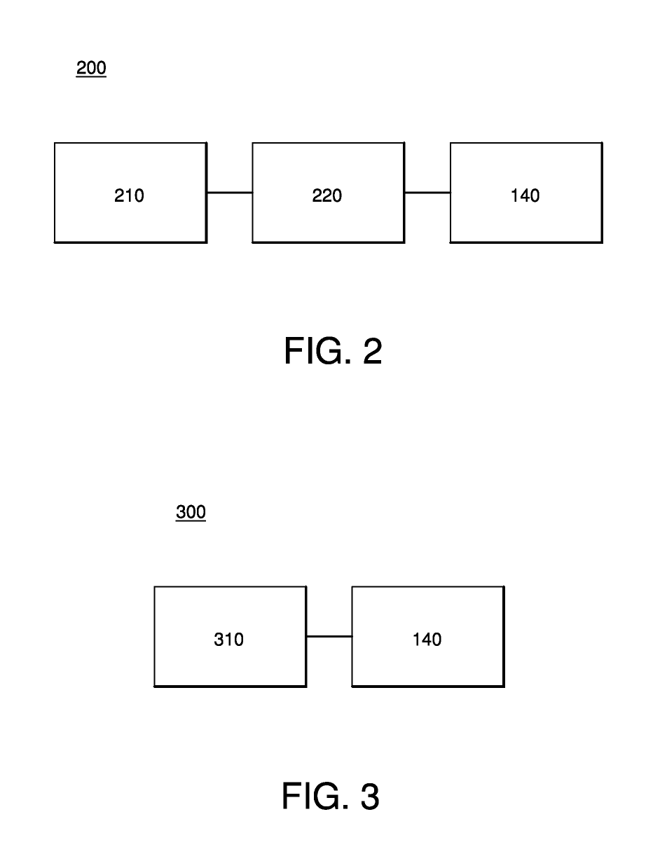

According to an aspect of the present invention, a neutron detector may be utilized to detect neutron radiation. Referring now also to FIG. 2, there is shown block diagram of a neutron detector 200 according to the present invention. As may be seen in FIG. 2, neutron detector 200 may include a confined element 210, wherein the confined element is suitable for reacting with neutrons, and a converter 220. Confined element 210 may take the form of a pressurized tube or rod of a gas, such as He3 or BF3, for example. Confined element 210 may be confined at an elevated pressure in the range of 5-60 atm in order to increase the resulting signal level of an incident neutron. More specifically, a pressure range from 35-45 atm may be used. Yet more specifically, a pressure level of 40 atm may be utilized. Increased pressures may provide increased signal strength resulting from the detector in response to incident neutrons. Increased pressures may also increase the background level, so a balance between background detection sensitivity may be performed.

While a liquid or a solid may also be used within the confined element, a gas may be used since the ionized particles of a gas travel more freely than those of a liquid or a solid. Typical gases used in detectors include argon and helium, although boron-triflouride may be utilized.

A central electrode, or anode, may collect negative charges within the detector. The anode may be insulated from the chamber walls of the detector and the cathode of the detector, which cathode collects positive charges. A voltage may be applied to the anode and the chamber walls. A resistor may be shunted by a parallel capacitor, so that the anode is at a positive voltage with respect to the detector wall. Thereby, as a charged particle passes through the gas-filled chamber, the charged particle may ionize some of the gas along its path of travel. The positive anode may attract the electrons, or negative particles. The detector wall, or cathode, may attract the positive charges. Collecting these charges may reduce the voltage across the capacitor, which may cause an electrical pulse across the resistor that may be recorded by an electronic circuit. The voltage applied to the anode and cathode may directly determine the electric field and its strength.

After a neutron interacts with element 210, a conversion in the neutron energy occurs and a photon or electron may be produced. Converter 220 may be utilized to detect the presence of a photon or electron. Converter 220 may take the form of a conventional detector used for detecting incident photons or electrons and convening detected particles into commensurate electrical signals. For example, if a photon is produced by the interaction of the incident neutron and confined elements 210, converter 220 may be utilized to detect the presence of the produced photon. Converter 220 may convert the produced photon or electron into an electrical signal. The electrical signal may be filtered and amplified as would be evident to those possessing an ordinary skill in the pertinent arts. The electrical signal may be read into a processor, such as a computer, such as by utilizing a channel on a multi-channel analyzer.

According to an aspect of the present invention, second detection channel 120 may be designed to detect the presence of x-ray radiation. Referring also now to FIG. 3, there is shown a block diagram of the x-ray detector 300 designed for detection of x-ray radiation according to an aspect of the present invention. Detector 300 may include a converter 310. Converter 310 may take the form of a detector suitable for detecting x-rays by converting x-rays into an electrical signal. The electrical signal may be read into a processor, such as a computer, utilizing a channel on a multi-channel analyzer. By way of a nonlimiting example, converter 310 may take the form of a CdTe detector.

In addition to detecting produced x-rays, detection of x-rays may be increasingly useful because of the bremsstrahlung, or secondary, x-ray affect. Bremsstrahlung, or braking radiation, is electromagnetic radiation with a continuous spectrum produced by the acceleration of a charged particle, such as an electron, proton, alpha or beta particle, when deflected by another charged particle, such as an atomic nucleus. Two classes of bremsstrahlung radiation exist. Outer bremsstrahlung radiation occurs where the energy loss by radiation greatly exceeds that by ionization as a stopping mechanism in matter, such as for electrons with energies above 50 MeV. Inner bremsstrahlung occurs, infrequently, from the radiation emission during beta decay, resulting in the emission of a photon of energy less than or equal to the maximum energy available in the nuclear transition. Inner bremsstrahlung may be caused by the abrupt change in the electric field in the region of the nucleus of the atom undergoing decay, in a manner similar to that which causes outer bremsstrahlung. In electron and positron emission, the photon's energy comes from the electron/neutron pair, with the spectrum of the bremsstrahlung decreasing continuously with increasing energy of the beta particle. In electron capture, the energy comes at the expense of the neutrino, and the spectrum is greatest at about one third of the normal neutrino energy, reaching zero at zero energy and at normal neutrino energy.

Bremsstrahlung is thus a type of secondary radiation that it is produced as a reaction in shielding material caused by the primary radiation. In some cases the bremsstrahlung produced by some sources of radiation interacting with some types of radiation shielding may be more harmful than the original beta particles would have been.

Detector 300 may be suitable for detecting radioactive material that is shielded within a metal. For example, as may be known to those possessing an ordinary skill in the pertinent arts, an alpha particle incident on a metal may produce an x-ray. Elements hidden within protective metal shields may emit alpha particles that impinge on the metal shield. The present device may detect this type of x-ray emission and by so doing detects the presence of elements producing alpha (or beta) particles. In particular, shielded elements which may produce such x-ray emission may include those with a long half-life.

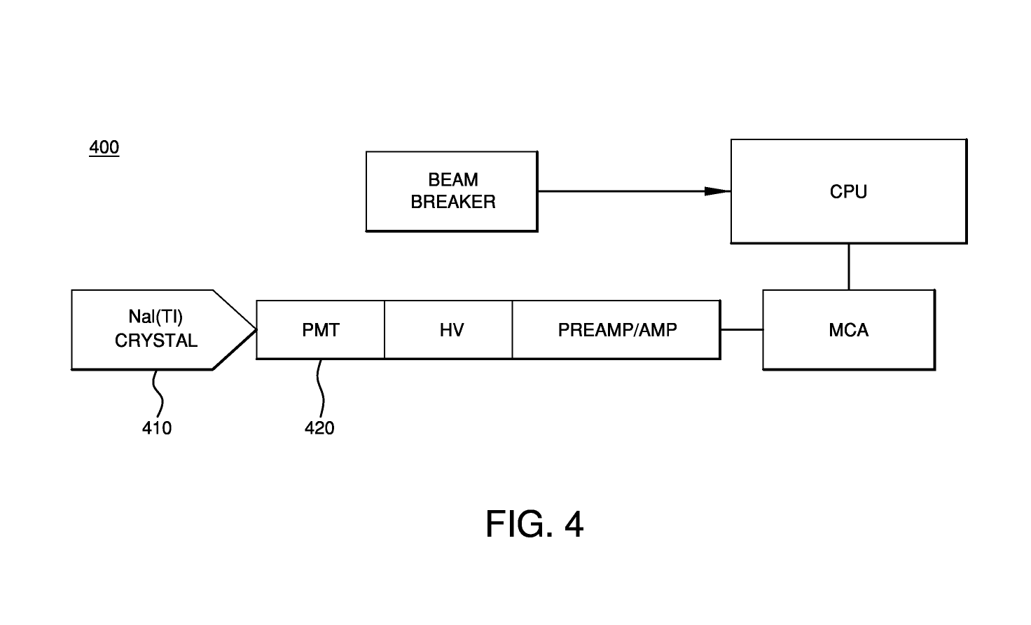

According to an aspect of the present invention, third detection channel 130 may be designed to detect the presence of and identify gamma radiation. Referring now also to FIG. 4, there is shown a block diagram of detector 400. As may be seen in FIG. 4, detector 400 may include a gamma ray sensor 410 and a converter 420. Gamma ray sensor 410 may take the form of a suitable device capable of converting incident gamma rays into a form capable of conversion into electrical signals. For example, sensor 410 may take the form of a crystal such as NaI or Ge(Li), for example. In such a configuration, gamma rays may interact with a NaI crystal sensor 410.

The detection efficiency of NaI crystals may improve with increasing crystal volume and the energy resolution may be dependent on the crystal growth conditions. Higher energy resolution is essential in radioactive counting situations where a large number of lines are present in a gamma ray spectrum.

A NaI crystal may output photons proportional to the gamma ray energy incident thereon. The height of the electronic pulse produced in a Ge(Li) detector also may be proportional to gamma ray energy.

With appropriate calibration, NaI and Ge(Li) detector systems may be used to determine the energies of gamma rays from other radioactive sources.

Converter 420 may be used to convert the output photons into electrical signals. Converter 420 may take the form of a photomultiplier tube, for example.

Other sensors 410 may be used within the detector of the present invention, and such other sensors may require use of alternative converters 420. Functionally, the combination of sensor 410 and converter 420 may convert incident gamma rays into a usable electrical signal that may be proportional to the energy of the incident gamma ray.

An electrical signal produced by the detector of the present invention may be filtered and amplified as would be evident to those possessing an ordinary skill in the pertinent arts. The electrical signal may be read into a processor, such as a computer, utilizing one or more channels on a multi-channel analyzer. It may be advantageous to use a common filtration and amplification system so that multiple channels may be calibrated in common. The number of channels used on the multi-channel analyzer may factor into the resolution of detector 400. For example, as is known to those possessing an ordinary skill in the pertinent arts, quantization effects may result in sampling data and sampling at lower than the nyquist frequency will produce data that may not be resolved into the component energies as necessary.

A multi-channel analyzer, as would be evident to those possessing an ordinary skill in the pertinent arts, may have a few channels, or up to thousands of channels. For the sake of discussion a 16K multi-channel analyzer may be used, providing approximately 16K channels for the gamma detector and at least one channel for each of the neutron and x-ray detectors.

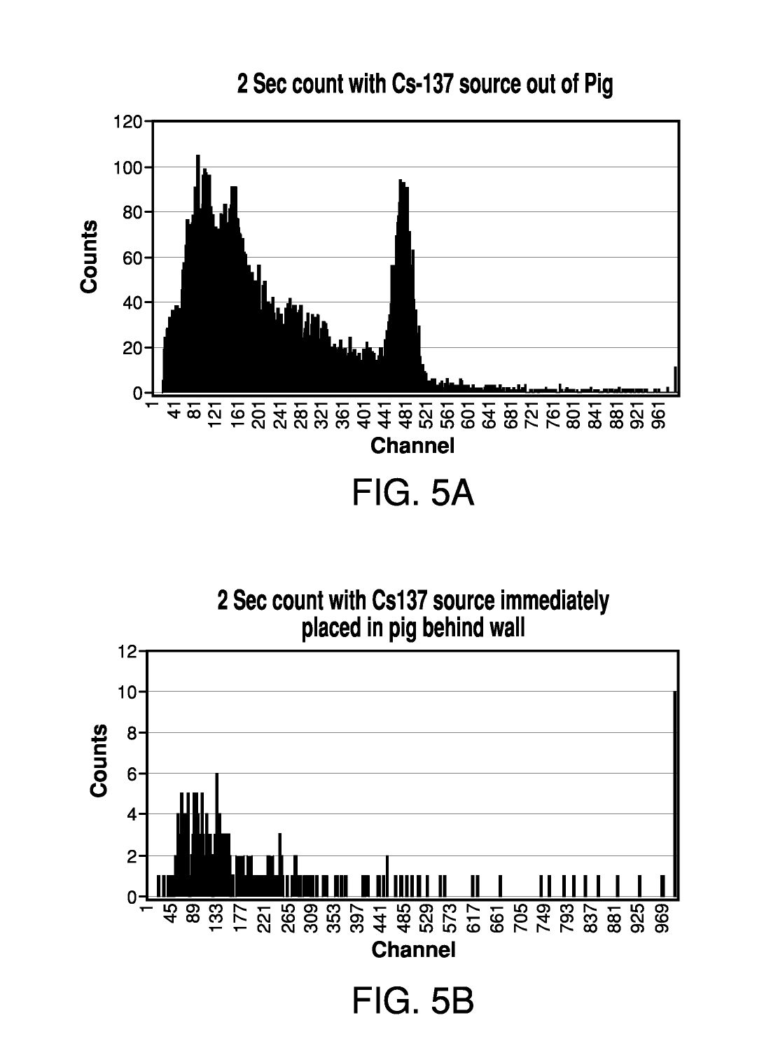

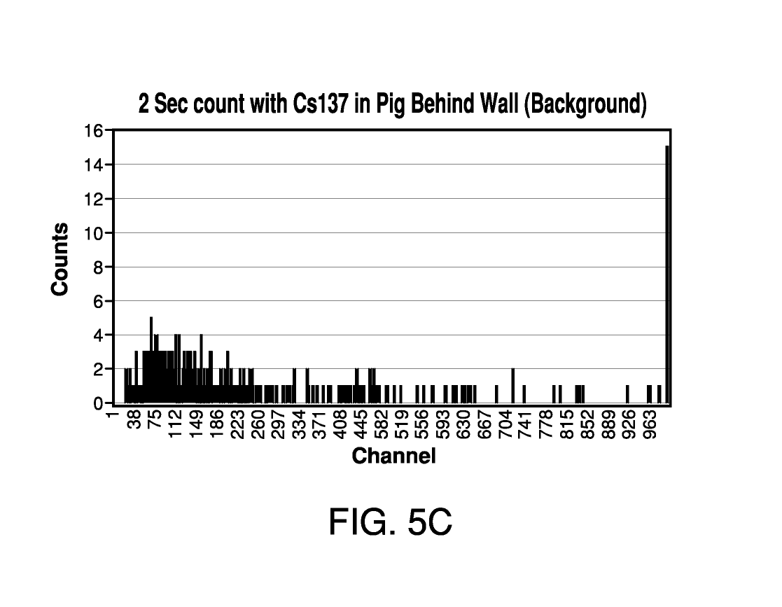

Referring now to FIGS. 5A-C, there are shown a spectra and baseline as may be detected by the gamma ray channel according to an aspect of the present invention. As may be seen in FIGS. 5A-C, a given gamma emitting material releases a constant amount of energy. Thus, for example, Cs 137 may produce channel peaks at approximately 81, 161, and 481 channels, by way of non-limiting example only. Each gamma source, similarly having a unique signature, may allow for the corresponding identification of sources.

The present gamma detection function may also be designed to enhance low level measurements. In particular, low level detection may occur at the level of approximately 10 .mu.Rem/hr for a 1 second integration time. This low level detection may be in the range 5-15 .mu.Rem/hr for a 1 second integration time—with background in approximately the 4 .mu.Rem/hr for a 1 second integration time range. Enhancement of the crystal, including size optimization, may increase the low level sensitivity to gamma detection.

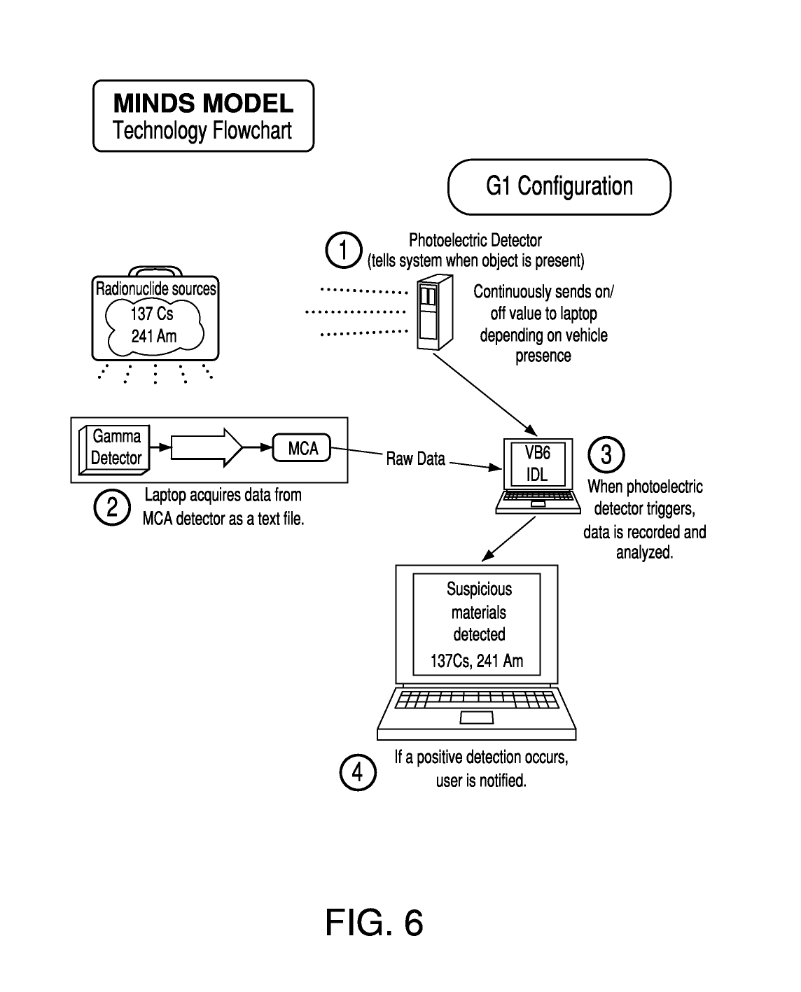

The configuration of the present invention provides for rapid identification of emissions and is linked to software. Referring now to FIG. 6, there is shown a configuration according to an aspect of the present invention. As may be seen in FIG. 6, a computer acquires data from the multichannel analyzer as discussed hereinabove. The raw data is transmitted to a processor. In addition to the raw data, an additional set of data from a photoelectric detector may be logged. The photoelectric detector identifies to the system when an object is present. This detector continuously sends an on/off value to the processor depending on the target presence. For example, if vehicles are to be monitored at a toll booth, the photoelectric detector may monitor the presence of a vehicle to be monitored. This may provide the system with information to determine which vehicle contains the emission of interest. Further, the system may be designed to record and analyze data when the photoelectric detector is triggered, thereby providing data only when a target is positioned as desired.

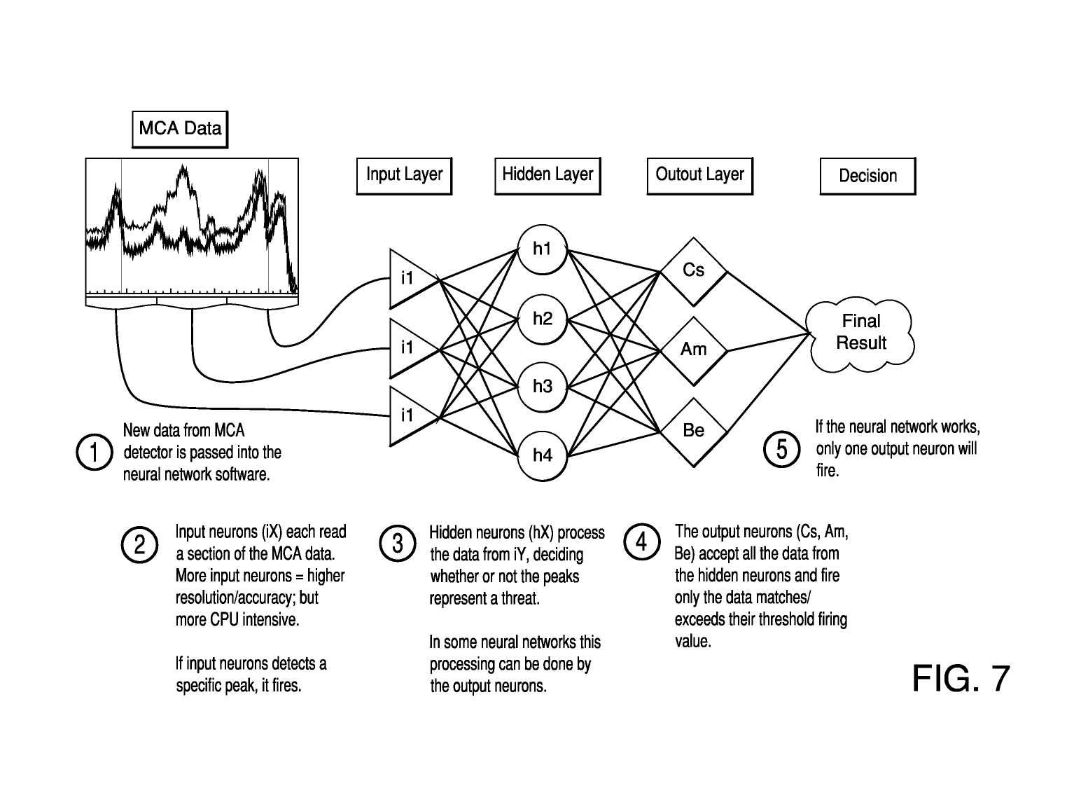

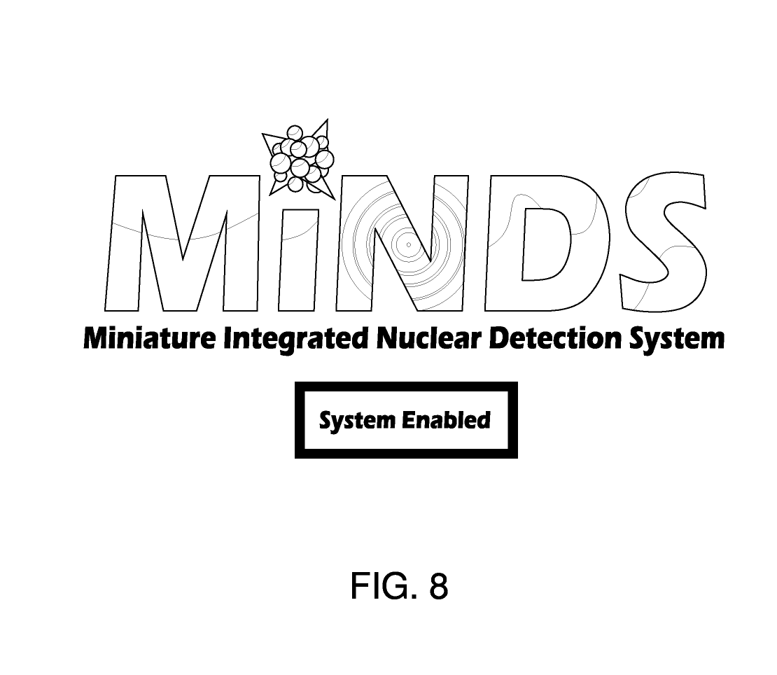

Referring now to FIG. 7, there is shown a neural networking configuration of the software according to an aspect of the present invention. According to an aspect of the present invention, the present software may take the form of advanced neural networking. Such a configuration may input the data from the multi channel analyzer (MCA) into the software system. As shown in the configuration of FIG. 7, input neurons read a designated portion of the input MCA data. Because of the quantization effect which may occur, the greater the number of input neurons, the higher the resolution and accuracy that may be achieved, but greater processing is required. If an input neuron detects a peak, it fires. A second stage of neurons, often called hidden neurons, may process the data from the input neurons (including whether the input neurons fired or not). This processing may result in determining if the peaks detected by the input neurons represent a threat. Output neurons may be linked to the second stage of neurons, and may represent particular elements that may be detected. The output neurons may fire when the second stage of neurons detect the presence of a given element associated with a particular output neuron. For example, if the second stage neurons determine the presence of cobalt 90, the output neuron associated with cobalt 90 may fire because the output neuron corresponding to cobalt 90 has exceeded its threshold condition. Ultimately, in the presence of a single isotope, a single output neuron may fire, namely the output neuron corresponding to the identity of the isotope detected. In such a configuration, the software may learn or adapt to conditions, such as weather, temperature, and solar. Further, the software may be able to detect an isotope even in the presence of systematic shifts in the data detection. Knowing that an isotope may have a signature that has a ratio between channels of 2:1 for example, wherein the channels are 200 channels apart, may allow the software to shift the incoming data when comparing to the known parameters. Software in this configuration provides greater matching abilities and may reduce the number of false positives or false negatives.

Additional software configurations may be implemented, including plotting the counts per channel on the MCA and comparing to known isotope curves to provide the identity of the isotope, or to provide a match to a preselected library of isotopes.

Further, the software may be varied accordingly, to be as sensitive or as insensitive as necessary, based on the radiation type or types to be searched for, and the distance between the potential radiation source and the detectors.

There are literally thousands of radionuclides presently known to exist. The present invention may include reference spectra of all such known radionuclides, or any subset of radionuclides as determined by a user. A consequence of having a large number of reference waveforms in a library resident in a storage device employed in the apparatus and methods of the invention, however, is to increase the analysis time required to make a decision. In addition, not all radionuclides are currently considered to be relevant or threatening. In the interests of providing a device that may be implemented in the field, certain nonlimiting embodiments of the present invention may restrict the identities of relevant and/or threatening radionuclides to a relatively smaller subset.

Many radionuclides can be identified by examining the characteristic gamma rays emitted in the decay of the radioactive parent nucleus. For example, two characteristic gamma rays occur in the decay of the radionuclide Na 22. The Na 22 decay occurs by one of two independent mechanisms. In each of the two beta decay branches, a positron and a neutrino are emitted, and the net nuclear charge changes from Z=11 to Z=10. In one decay branch, the Na 22 ground state is stable; however, the first excited state of Na 22 at about 1.275 MeV decays with a lifetime of 3.7 ps in the gamma decay process, which gives rise to a characteristic gamma ray with energy of about 1.275 MeV. The positrons slow rapidly in the radioactive source material and disappear in the annihilation process, producing two characteristic 0.511 MeV annihilation gamma rays. In the other decay branch, an atomic electron may be captured by the Na 22 nucleus in the reaction, and a monoenergetic neutrino may be emitted. The electron capture process populates only the first excited state of Na 22 at 1.275 MeV and therefore characteristic 1.275 MeV gamma rays result. Annihilation gamma rays at 0.511 MeV are not produced in electron capture because positrons are not created.

For example, for Co 60 spectra, two main gamma ray peaks above 1 MeV are evident. In analyzing the spectra, a centroid of the energies peaks including the associated uncertainties may be apparent. Comparison of the data with known energy level diagrams, as would be evident to those possessing an ordinary skill in the pertinent arts, may thus be performed. A source may be identified by comparing the centroids of the energy peaks with a chart of the nuclides and/or a table of isotopes.

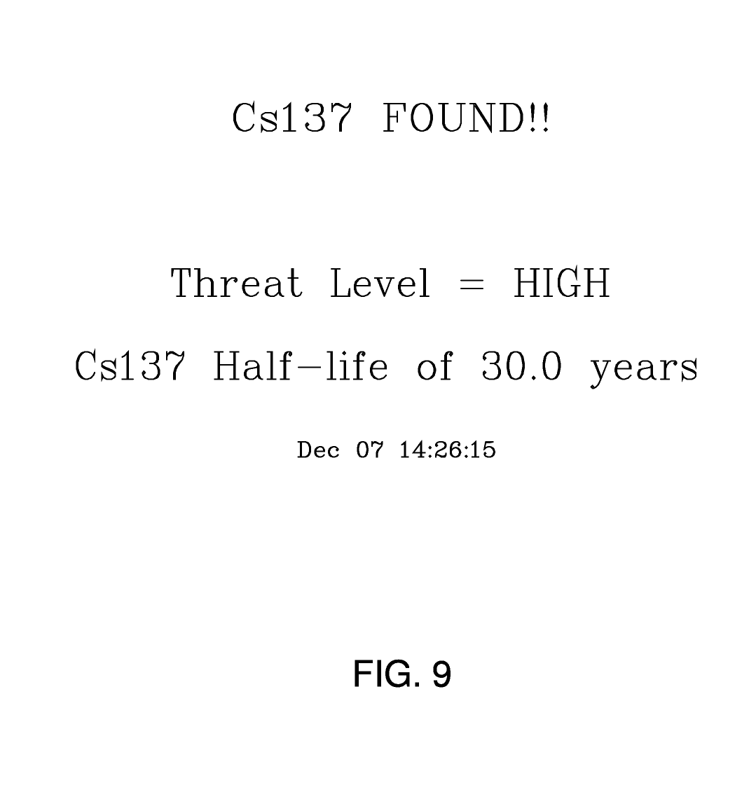

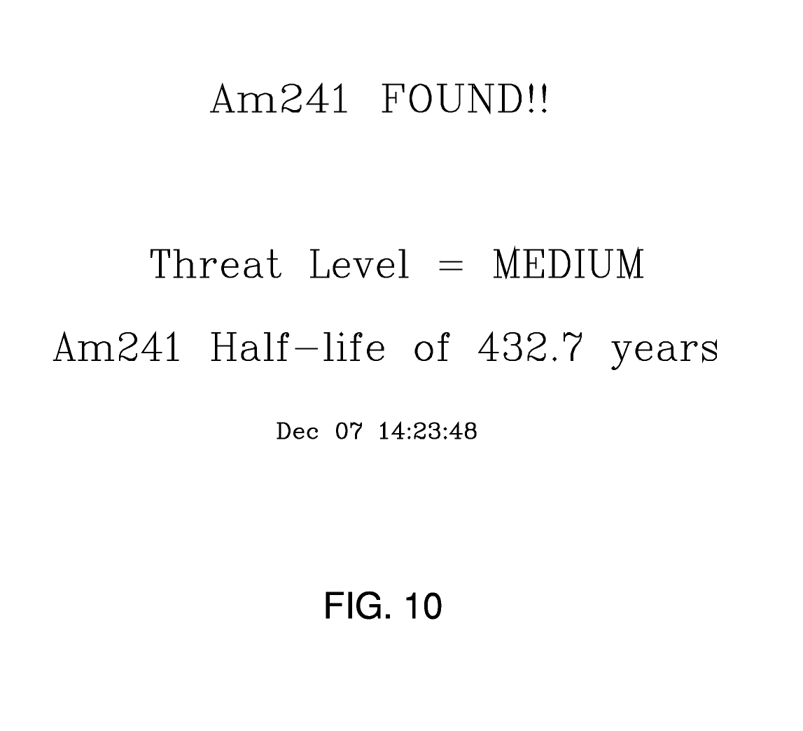

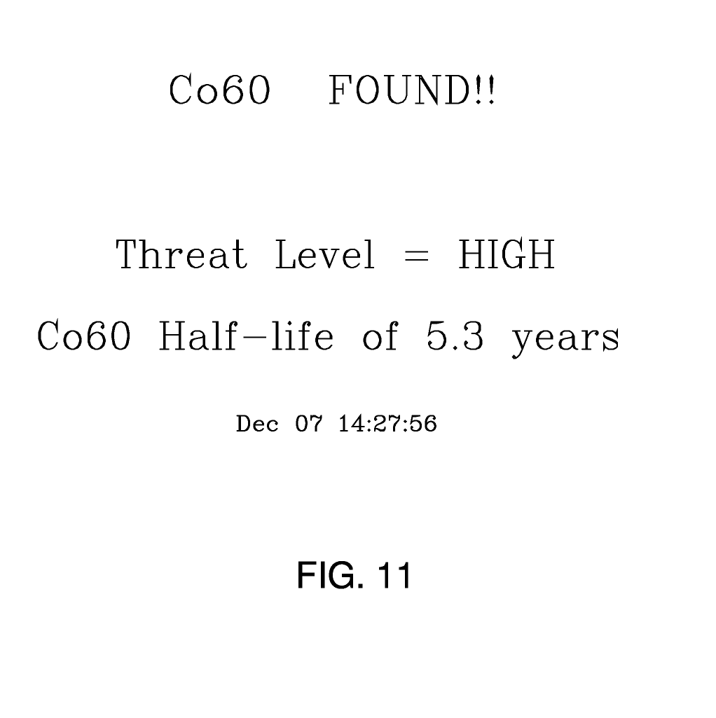

Referring now to FIGS. 8-11, there are shown screen shots associated with the software of the present invention. As may be seen in FIG. 8, a start-up and all systems go screen is shown. This screen enables a operator to determine if the system is working and, if so, if the present invention is functioning properly. FIGS. 9-11 show alert pages for various emission. For example, in FIG. 9, there is shown a screen shot associated with a Cs 137 detection. In addition to informing the user of a positive detection, the threat level is provided (which is high for Cs 137), and the half-life of the detected isotope may be provided (which is 30 years for Cs 137). Also provided is a timestamp of the alert time and date. Similarly, as may be seen in FIG. 10, there is shown a screen shot of a detected Am 241 alert page. The threat level for Am 241 is defined as medium, and the page conveys that Am 241 has a 432.7 year half-life. Further, the alert is time stamped for ease of reference. As may be seen in FIG. 11, there is shown an alert page for the alert of Co 60. Co 60 has a high threat level and a half-life of 5.3 years. Again the time and date stamp is provided. Additional information may be provided and the present screen shots show the features of an exemplary embodiment of the present system. Other features may be provided via screen shots, such as, in embodiments wherein one or more detectors are used, or wherein one or more detectors are given certain fields of view or certain assigned angles of a field of view, providing using the screen shots information on distances of radionuclides from the one or more detectors, and amounts of radionuclides within the view field of the one or more detectors.

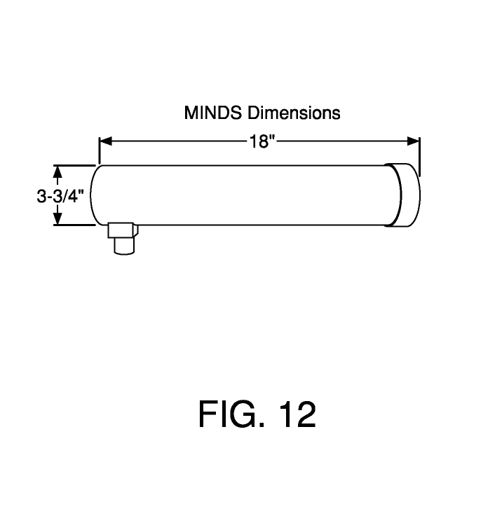

Referring now to FIG. 12, there is shown a housing according to an aspect of the present invention. As may be seen in FIG. 12, the present invention may be designed in a relatively small and light configuration. While many other housing and storage mechanisms may be employed, this exemplary housing is illustrated solely for the purpose of demonstrating the size and weight benefits of the system of the present invention. The housing may be made from a suitable material or materials. According to an aspect of the present invention, a PVC enclosure may be utilized. Such a configuration may include an internal metal shield to prevent or limit electrical and environmental disturbances. Aluminum enclosures may also be utilized. Such a configuration may also include an internal metal shield. Kevlar or other protective elements may also be used. As is known to those possessing an ordinary skill in the pertinent arts, products such as Kevlar may be utilized to provide high strength protection in a light weight configuration. The enclosure of the present invention may be designed to withstand fill immersion in water. This may be accomplished by using o-ring designs, for example. Additionally, a weather-proof design may be beneficial to provide independence or minimize reaction to the surrounding environment. The present invention may be designed to work over a substantial temperature range. For example, according to an aspect of the present invention, the system described herein may be designed to operate from −25 to +55 degrees C.

An advantage of the self-contained detecting portion of the present invention is that it may be installed with ease in any location whereat its use is desired or recommended. By way of a nonlimiting example, a housing incorporating a detector is shown in FIG. 12. The housing may have a diameter of approximately 4.5 inches and a length of approximately 17 inches. The housing may contain system 100 including first detection channel 110, second detection channel 120 and third detection channel 130. Processing 140 may be contained within, or coupled but not contained within, the housing as determined by size and weight requirements, and this processing may be for one or more of the channels for interpreting and analyzing the data from that one or more channel. The housing as shown, and similar embodiments of a housing, may accommodate at least three detectors; nonlimiting examples of which may include a NaI detector, a cadmium-zinc-telluride detector, and a neutron detector based either on BF3 or He3 as the active element. A cable may exit the housing shown in FIG. 12 and electrically connect to a processor suitable for performing the processing function described hereinabove. Similarly, in environments allowing for such a connection, a wireless connection may be employed between the detector and the processing, and/or between the processing and one or more monitoring locations. For example, a wired or wireless connection may allow for a monitoring of multiple sites having a detector and processing from a single monitoring location.

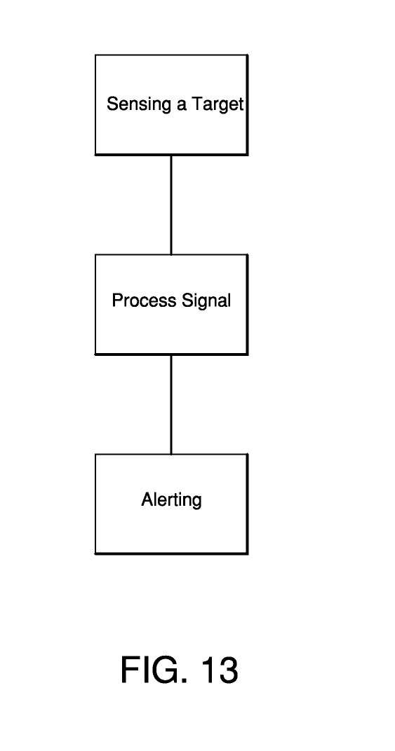

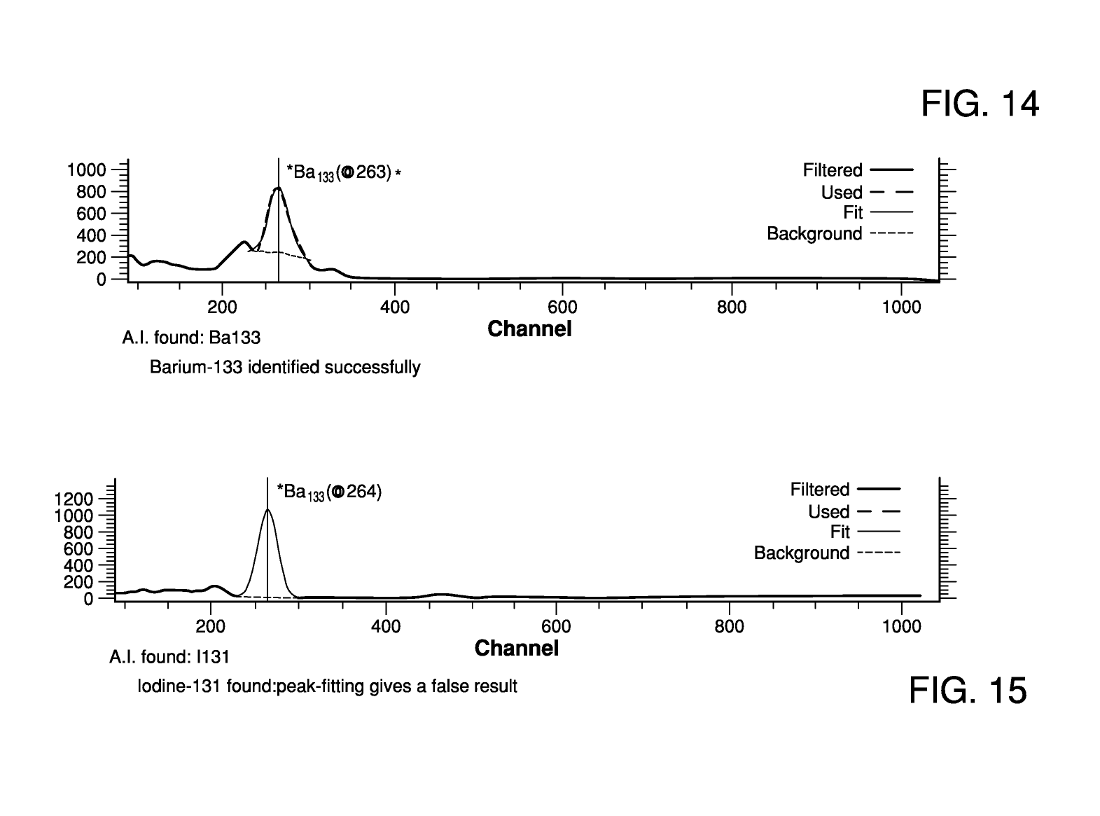

Referring now to FIG. 13, there is shown a method of detecting radionuclides according to an aspect of the present invention, such as in accordance with the exemplary embodiments of FIGS. 1 through 12 hereinabove. Method 1300 may include sensing a target using one or more suitable detectors. Method 1300 may also include processing the signal resulting from the detection of the target in order to detect the presence of or identify the type of radionuclides present. Method 1300 may also include an alert responsive to the detected or identified radionuclides in the present target.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

1. A detector for detecting the presence of suspect radionuclides in a target, said detector comprising:
a first detection channel for a first detecting neutron emissions in the target and for providing a first output in accordance with the first detecting;
a second detection channel for a second detecting x-ray emissions in the target and for providing a second output in accordance with the second detecting;
a third detection channel for a third detecting and an identifying of gamma emissions in the target and for providing a third output in accordance with the third detecting and identifying;
a processor electrically coupled to each of said first, second, and third detection channels, said processor for receiving the first, second and third outputs; and,
wherein said processor determines if the suspect radionuclide is present in the target and provides an alert when the suspect radionuclide is present in the target; and
wherein said processor determination occurs only when said processor is exposed to a lower level of detection of about 10 μRem/hr for a period of about one second.

2. The detector of claim 1, wherein said first detection channel comprises a confined element.

3. The detector of claim 2, wherein said first detection channel comprises a converter.

4. The detector of claim 2, wherein said confined element is suitable for reacting with neutrons.

5. The detector of claim 2, wherein said confined element is a pressurized tube of a gas.

6. The detector of claim 5, wherein said confined element is He3.

7. The detector of claim 5, wherein said confined element is pressurized in the range of 5-60 atm.

8. The detector of claim 5, wherein said confined element is pressurized in the range of 35-45 atm.

9. The detector of claim 5, wherein said confined element is pressurized to approximately 40 atm.

10. The detector of claim 1, wherein said second detection channel comprises a converter.

11. The detector of claim 1, wherein said third detection channel comprises a gamma ray sensor and a converter.

12. The detector of claim 11, wherein said gamma ray sensor converts gamma rays into photons.

13. The detector of claim 11, wherein said gamma ray sensor is a crystal.

14. The detector of claim 13, wherein said crystal is NaI.

15. The detector of claim 11, wherein said converter converts the output of said sensor to electrical signals.

16. The detector of claim 15, wherein said converter converts output photons into electrical signals.

17. The detector of claim 16, wherein said converter is a photomultiplier tube.

18. The detector of claim 1, wherein said processing includes electrical filtration.

19. The detector of claim 1, wherein said processing includes signal amplification.

20. The detector of claim 1, wherein said processing includes a multichannel analyzer.

21. The detector of claim 1, wherein said at least one processor comprises neural networking.

22. The detector of claim 21, wherein said neural networking comprises at least one set of neurons.

23. The detector of claim 21, wherein said neural networking comprises first set of neurons coupled to the outputs of at least one channel, and a second set of neurons coupled to the output of said first set of neurons.

24. The detector of claim 23, wherein said first set of neurons comprises input neurons.

25. The detector of claim 23, wherein said second set of neurons comprises output neurons.

26. The detector of claim 23, wherein said neural networking further comprises alerts coupled to the output of said second set of neurons.

27. The detector of claim 23, wherein said neural networking further comprises at least one spectra of at least one target radionuclide.

28. The detector of claim 27, wherein said at least one spectra is commensurate with said second set of neurons.
